(19) United States
(12) Patent Application Publication
(10) Pub. No.: US 2026/0271087 A1
(43) Pub. Date: Sep. 10, 2026

(54) METHOD, APPARATUS AND COMPUTER PROGRAM

(71) Applicant: Nokia Technologies Oy, Espoo (FI)

(72) Inventors: Smita SHETTY, Bangalore (IN); Sami-Jukka HAKOLA, Oulu (FI)

(21) Appl. No.: 19/551,283

(22) Filed: Feb. 26, 2026

(30) Foreign Application Priority Data
Mar. 6, 2025 (IN) 202541020309

(51) Int. Cl. H04W 74/0833

(52) U.S. Cl. CPC H04W 74/0833

(57) ABSTRACT

There is provided a method, apparatus and computer program for causing an apparatus to perform: receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier; selecting the second carrier; identifying, based on the system information, at least one second random access occasion for performing an uplink random access transmission over the second carrier provided by the multi-carrier cell; and transmitting an uplink random access message over the second carrier during the identified at least one second random access occasion.

### TECHNICAL FIELD

Various example embodiments of this disclosure relate to a method, apparatus, system and computer program and in particular but not exclusively to identifying at least one random access occasion for transmitting an uplink random access message.

### BACKGROUND

A communication network can be seen as a facility that enables communications between two or more communication devices, or provides communication devices access to a data network. A mobile or wireless communication network is one example of a communication network. A communication device may be provided with a service by an application server.

Such communication networks operate in according with standards such as those provided by 3GPP (Third Generation Partnership Project) or ETSI (European Telecommunications Standards Institute). Examples of standards are the so-called 5G (5th Generation) standards and 6G (6th Generation) standards provided by 3GPP.

### SUMMARY

Some example embodiments of this disclosure will be described with respect to certain aspects. These aspects are not intended to indicate key or essential features of the embodiments of this disclosure, nor are they intended to be used to limit the scope of thereof. Other features, aspects, and elements will be readily apparent to a person skilled in the art in view of this disclosure.

According to a first aspect, there is provided an apparatus comprising means for performing: receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier; selecting the second carrier; identifying, based on the system information, at least one second random access occasion for performing an uplink random access transmission over the second carrier provided by the multi-carrier cell; and transmitting an uplink random access message over the second carrier during the identified at least one second random access occasion.

According to a second aspect, there is provided an apparatus comprising: at least one processor; and at least one memory comprising code that, when executed by the at least one processor, causes the apparatus to perform: receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier; selecting the second carrier; identifying, based on the system information, at least one second random access occasion for performing an uplink random access transmission over the second carrier provided by the multi-carrier cell; and transmitting an uplink random access message over the second carrier during the identified at least one second random access occasion.

According to a third aspect, there is provided a method for an apparatus, the method comprising: receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier; selecting the second carrier; identifying, based on the system information, at least one second random access occasion for performing an uplink random access transmission over the second carrier provided by the multi-carrier cell; and transmitting an uplink random access message over the second carrier during the identified at least one second random access occasion.

According to a fourth aspect, there is provided an apparatus comprising: receiving circuitry for receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier; selecting circuitry for selecting the second carrier; identifying circuitry for identifying, based on the system information, at least one second random access occasion for performing an uplink random access transmission over the second carrier provided by the multi-carrier cell; and transmitting circuitry for transmitting an uplink random access message over the second carrier during the identified at least one second random access occasion.

The following may apply in respect of any (e.g., one or more, including all) of the above first to fourth aspects.

The selecting the second carrier may comprise: determining a plurality of carriers supported by the multi-carrier cell, wherein the plurality of carriers comprises at least the first carrier, the second carrier, and a third carrier; determining that the third carrier corresponds to a lower frequency range than the second carrier; and selecting the second carrier based on the determination that the third carrier corresponds to a lower frequency range than the second carrier.

The second carrier may correspond to a highest frequency range available out of the plurality of carriers.

The apparatus may be caused to perform: determining that a random access procedure initiated by the uplink random access message transmission over the second carrier has failed; determining that the third carrier has a second highest frequency range available out of the plurality of carriers; and selecting the third carrier for transmission of another uplink random access message based on the determination that the third carrier has a second highest frequency range available out of the plurality of carriers and the failure of the random access procedure initiated by the uplink random access message transmitted over the second carrier.

The selecting the second carrier may comprise: determining a plurality of carriers supported by the multi-carrier cell, wherein the plurality of carriers comprises at least the first carrier, the second carrier, and a third carrier; determining that the second carrier corresponds to a higher frequency range than that of the third carrier; determining that a power headroom of the apparatus would be equal to or more than a threshold amount of zero if the uplink random access message is transmitted over the second carrier; and selecting the second carrier based on the preceding two determinations.

The selecting the second carrier may comprise: determining a plurality of carriers supported by the multi-carrier cell, wherein the plurality of carriers comprises at least the first carrier, the second carrier, and a third carrier; determining that the second carrier corresponds to a lower frequency range than the third carrier; determining that a power headroom of the apparatus would be equal to or more than a threshold amount of zero if the uplink random access message is transmitted over the second carrier; determining that the power headroom of the apparatus would be within the threshold amount of zero if the uplink random access message is transmitted over the third carrier; and selecting the second carrier based on the preceding three determinations.

The identifying the at least one second random access occasion may comprise: identifying the second carrier; receiving an association between the second carrier and the at least one second random access occasion; and identifying the at least one second random access occasion based on the identified second carrier, and the association between the second carrier and the at least one second random access occasion.

The identifying the at least one second random access occasion may comprise: mapping the at least one of the synchronisation signal blocks transmitted over the first carrier to the at least one second random access occasion using a mapping algorithm.

The identifying the at least one second random access occasion may comprise: determining a mapping algorithm between the synchronisation signals blocks and the first random access occasions based on the system information; identifying a reference signal of the second carrier that is quasi co-located to at least one of said synchronisation signal blocks; and identifying the at least one second random access occasion based on the determined mapping algorithm and the identified at least one quasi-collocated resource.

The second carrier may be associated with a tracking reference signal.

The tracking reference signal may be quasi-collocated with at least one of said synchronisation signal blocks, and wherein the quasi-colocation is based on at least one of a spatial receive parameter, a Doppler shift, or an average receive delay time.

The apparatus may further be caused to perform: receiving a downlink random access message after transmitting the uplink random access message, wherein the downlink random access message is received on resources that are quasi-collocated with resources used for transmission of the random access preamble on the uplink

The apparatus may be a User equipment, UE. The apparatus may be comprised in a UE.

The apparatus may be caused to perform: determining that the apparatus is not configured to transmit uplink over the first carrier, wherein the identifying is performed based on said determining that the apparatus is not configured to transmit uplink over the first carrier.

According to an aspect, there is provided a non-transitory computer readable medium comprising program instructions that, when executed by an apparatus, cause the apparatus to perform at least the method according to any of the preceding aspects.

In the above, many different embodiments have been described. It should be appreciated that further embodiments may be provided by the combination of any two or more of the embodiments described above.

### DESCRIPTION OF FIGURES

Some example embodiments will now be described, by way of non-limiting and illustrative example only, with reference to the accompanying Figs. in which:

FIG. 1 shows a representation of a communication system;

FIG. 2 shows a representation of an apparatus for the communication system of FIG. 1 according to some example embodiments;

FIG. 3 shows a representation of an apparatus according to some example embodiments;

FIGS. 4A and 4B illustrate random access signalling procedures;

FIG. 5 illustrates an example multi-carrier cell;

FIG. 6 illustrates example transmissions in a multi-carrier cell;

FIG. 7 illustrates example signalling between apparatus described herein;

FIG. 8 illustrates example methods that may be performed by apparatus described herein; and

FIGS. 9 to 11 illustrate example methods that may be performed by apparatus described herein.

### DETAILED DESCRIPTION

The following relates to methods, apparatus, and computer programs for identifying at least one random access occasion for performing an uplink random access transmission in a multi-carrier cell.

In more detail, the following considers the case in which an apparatus is configured to receive system information on a first carrier provided by the multi-carrier cell, and to transmit an uplink random access message (e.g., a random access preamble) on a second (e.g., different) carrier of the multi-carrier cell.

The described methods may be useful in scenarios in which the apparatus is able to receive signalling on the frequency band associated with (e.g., corresponding to) the first carrier but is unable to transmit signalling on the frequency band associated with the first carrier. It is understood, however, that an apparatus that is not constrained in such a way may still be caused to operate the method and principles described herein.

Although this will be described in more detail below, by way of example, the following first presents an example communication environment (in which example embodiments of the present disclosure can be implemented) and example apparatus that may implement at least one of the presently described features. It is understood that the presently described methods are not limited to such a communication environment and apparatus.

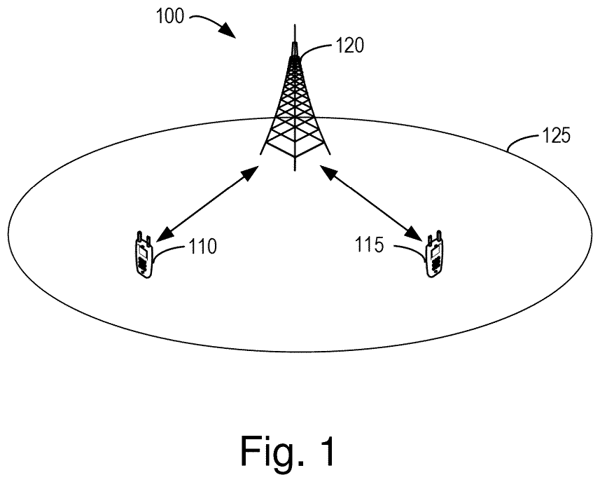

FIG. 1 shows an example communication environment 100 in which example embodiments of the present disclosure can be implemented.

In the communication environment 100, a plurality of communication devices, comprising user devices 110 and 115 (also referred to herein as a “terminal” or “terminal device”) and a network device 120 (also referred to herein as a “network access node”), can communicate with each other. The network device 120 may serve a coverage area, called a cell 125. The user device 110 may have access to a communication network via the cell 125. In some example embodiments, both the user device 110 and the network device 120 may be configured to implement a beamforming technique and communicate with each other via a plurality of beams.

The term “terminal device” refers to any end device that may be capable of wireless communication. By way of example rather than limitation, a terminal device may also be referred to as a communication device, user equipment (UE), a Subscriber Station (SS), a Portable Subscriber Station, a mobile device, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), a machine-type communications (MTC) device, an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to a Mobile Termination (MT) part of an Integrated Access and Backhaul (IAB) node (e.g., a relay node). In the following description, the terms “terminal device”, “communication device”, “terminal”, “user device”, “user equipment” and “UE” may be used interchangeably.

As used herein, the term “network device” is used interchangeably with “network access node”, and refers to a node in a communication network via which a terminal device accesses the network and receives services therefrom. The network device may refer to a base station (BS) or an access point (AP), for example, a node B (NodeB or NB), an evolved NodeB (eNodeB or eNB), an NR NB (also referred to as a gNB), a Remote Radio Unit (RRU), a radio header (RH), a remote radio head (RRH), a relay, an IAB node, a low power node such as a femto, a pico, a non-terrestrial network (NTN) or non-ground network device such as a satellite network device, a low earth orbit (LEO) satellite and a geosynchronous earth orbit (GEO) satellite, an aircraft network device, and so forth, depending on the applied terminology and technology. In some example embodiments, radio access network (RAN) split architecture comprises a Centralized Unit (CU) and a Distributed Unit (DU) at an IAB donor node. An IAB node comprises a Mobile Terminal (IAB-MT) part that behaves like a UE toward the parent node, and a DU part of an IAB node behaves like a base station toward the next-hop IAB node.

In some example embodiments, a link from the network device 120 to the user device 110 or 115 is referred to as a downlink (DL), while a link from the user device 110 or 115 to the network device 120 is referred to as an uplink (UL). Links are also referred to herein as “channels”. In DL, the network device 120 is a Tx device (or a transmitter), and the user device 110 or 115 is a Rx device (or a receiver). In UL, the user device 110 or 115 is a Tx device (or a transmitter), and the network device 120 is a Rx device (or a receiver). A link between the user device 110 and another user device (not shown) is referred to as a sidelink (SL). In SL, one of the user devices is a Tx device (or a transmitter), and the other of the user devices is a Rx device (or a receiver).

Communications in the communication environment 100 may be implemented according to any proper communication protocol(s), comprising, but not limited to, cellular communication protocols of the first generation (1G), the second generation (2G), the third generation (3G), the fourth generation (4G), the fifth generation (5G), the sixth generation (6G), and the like, wireless local network communication protocols such as Institute for Electrical and Electronics Engineers (IEEE) 802.11 and the like, and/or any other protocols currently known or to be developed in the future. Moreover, the communication may utilize any proper wireless communication technology, comprising but not limited to: Code Division Multiple Access (CDMA), Frequency Division Multiple Access (FDMA), Time Division Multiple Access (TDMA), Frequency Division Duplex (FDD), Time Division Duplex (TDD), Multiple-Input Multiple-Output (MIMO), Orthogonal Frequency Division Multiple (OFDM), Discrete Fourier Transform spread OFDM (DFT-s-OFDM) and/or any other technologies currently known or to be developed in the future.

Reference in the below is made to random access procedures and initial access signalling. As an example, the following provides an overview of such systems in a 3GPP context. It is understood that the following is understood as providing an illustrative overview of how some systems may operate, and that the actual connection and random access procedures may vary. It is also understood that although 5G is referenced below, similar procedures and signalling may be applied in 6G and beyond.

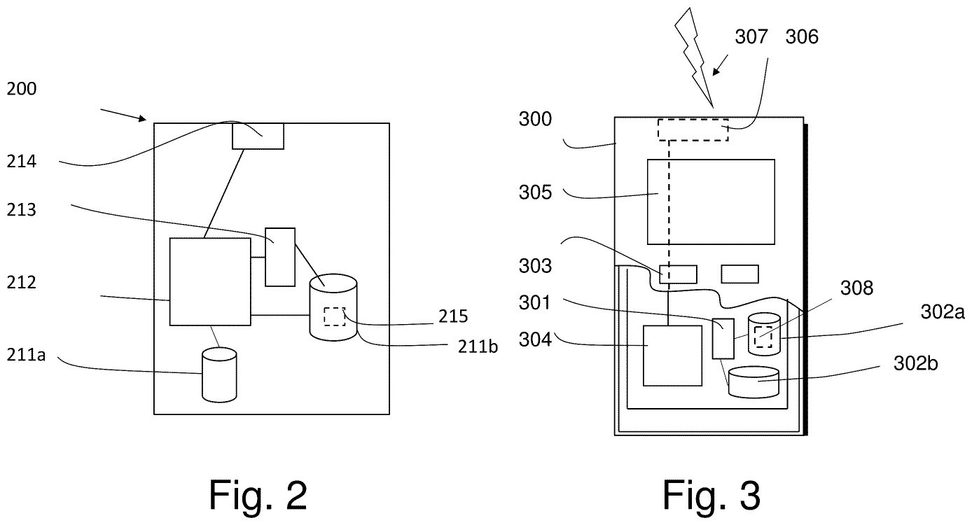

In 5G New Radio (NR), initial cell search, and initial time and frequency synchronization acquisition are based on a UE (such as illustrated in FIGS. 1 and 3) searching and detecting a synchronisation signal block (SSB) from a network access node (such as illustrated in FIGS. 1 and 2).

The SSB comprises a synchronisation signal part and a broadcast part. The synchronisation signal part comprises a Primary Synchronization Signal (PSS) and a Secondary Synchronization Signal (SSS), which are collectively referred to herein as synchronisation signals. The broadcast part comprises a physical broadcast channel (PBCH) and a demodulation reference signal (DMRS) for PBCH demodulation. The MIB in the PBCH provides information about when the SIB1 is scheduled.

In more detail, performing, by a UE, a cell search on parts of an SSB may comprise performing at least one of the following features:

PSS detection: A PSS is a predetermined sequence modulated with a predetermined binary phase shift keying (BPSK) scheme. The PSS serves as a flag that shows where to find network access node information in the time-frequency grid. Therefore, a UE may use a detected PSS to assist in locating network access node information in the time-frequency grid.

SSS detection: An SSS is another predetermined sequence modulated using a BPSK scheme. The time-frequency location of the SSS can be determined from information gathered from the PSS reception. The UE may also use a detected SSS to assist in locating network access node information in the time-frequency grid.

DMRS detection for physical broadcast channel (PBCH): The DMRS is a type of signal whose time-frequency position and content are known at both the network access node and UE sides, once the physical cell identity (PCI) of a cell on which the SSB is transmitted is known at the UE side. The PBCH allows the UE to determine the effect of the wireless channel on a signal's amplitude and phase so that it can be predicted and reverted for related received signals of unknown content. DMRS detection helps the UE to correctly demodulate signals on the physical broadcast channel (PBCH).

PBCH demodulation: The PBCH physical channel comprises information/signals located in multiple locations of time and frequency. By using the estimations of the wireless channel computed from the PBCH DM-RSs, information broadcast on the PBCH may be demodulated and decoded. This information may comprise a master information block (MIB), and at least one System information block (SIB). At least one of the SIB may be comprised in the MIB. For example, SIB1 scheduling information may be comprised in the MIB.

The MIB and at least one SIB are cumulatively referred to as “system information” (SI).

In more detail, system Information (SI) may be considered to comprise a MIB and a number of SIBs, which are divided into Minimum system information and Other system information (OSI).

Minimum system information comprises basic information required by a UE for initial cell access and information for acquiring the Other system information. The Minimum system information comprises both the MIB and a first SIB (SIB1).

The MIB comprises cell barred status information and essential physical layer information of the cell required to receive further system information, e.g. CORESET #0 configuration. MIB is periodically broadcast on the cell's broadcast channel (BCH).

SIB1 defines the scheduling of other system information blocks and comprises information required by a UE for initially accessing the cell. SIB1 is also referred to as Remaining Minimum SI (RMSI) and is periodically broadcast on the downlink shared channel (DL-SCH) or sent in a dedicated manner on the DL-SCH to UEs that are in a radio resource control (RRC) connected state (RRC_CONNECTED) with the network access node.

After the cell search procedure has been performed, the UE may initiate a random access procedure to the network access node. The random access procedure may be a contention based random access (CBRA) procedure or a contention free random access (CFRA) procedure. Although these are described further below, it is understood that the presently described techniques may be applied in respect of any of these types of random access procedures.

Some random access procedure configuration information may be provided via an SIB. For example, a SIB1 comprises random access configuration information (e.g., a random access configuration) that indicates the resources that the UE is to use to communicate with the network access node during a random access procedure. The random access configuration information may indicate, for example, the resources allocated by the network access node for a Physical random access channel (PRACH) procedure. For example, the random access configuration may indicate the resources allocated by the network for the UE to transmit a PRACH preamble and to receive a random access response. The random access configuration may also indicate the size of a random access response window during which the UE is to monitor for a response to a PRACH preamble. The random access configuration may further specify that the random access response window starts a certain number of sub-frames after the end of the PRACH preamble in some examples. After obtaining the MIB, the RMSI and/or the OSI, the UE may thus perform a random access procedure for initial access to the RAN.

These random access resources to be used for transmission of a PRACH preamble may also be referred to as random access occasions. The random access occasions may be time duplex multiplexed and/or frequency duplex multiplexed. The random access occasions may be mapped to SSB beam indices. When a UE finds a suitable SSB beam, the UE carries out a random access-related procedure (e.g., transmission of a PRACH preamble) in the associated random access occasion. Reception of the preamble on a particular random access occasions is an implicit indication to a network access node that subsequent random access-related messages that are transmitted and/or received during the random access procedure will be carried out on the same SSB beam. The random access occasions to SSB beam index mapping information is broadcast by the network in the SIB1.

In more detail, SIB1 comprises the following higher layer parameters which. are used to indicate the random access occasions:
prach-ConfigurationIndex, which provides the location, number and duration of the random access occasions in time domain,
Msg1-FDM, which provides the number of frequency domain multiplexed random access occasions for each time location of a PRACH occasion according to prach-ConfigurationIndex and
ssb-perRACH-OccasionAndCB-PreamblesPerSSB, which provides both a number of SSB indexes per random access occasion, and a number of contention-based preambles per SSB index.

The UE may use these three parameters to derive, among other quantities, the so-called SSB-to-random access occasion mapping.

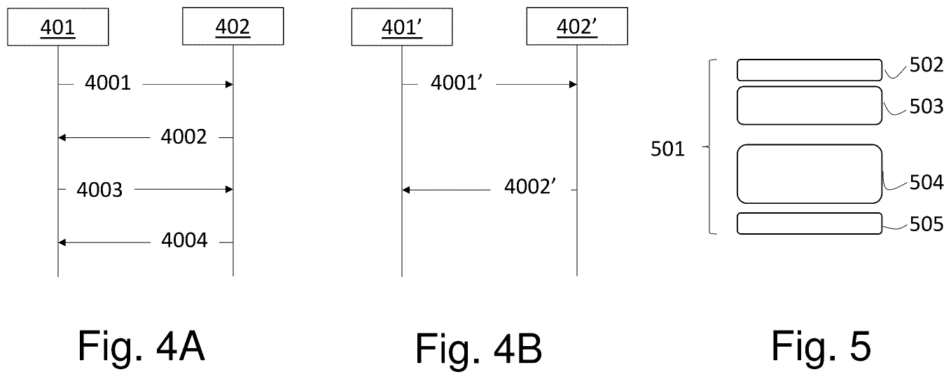

Example random access procedures are illustrated with respect to FIGS. 4A and 4B. In more detail, FIG. 4A illustrates a 4 step random access procedure, and FIG. 4B illustrates a 2 step random access procedure.

FIG. 4A illustrates signalling that may be performed between a UE 401 and a network access node 402.

During 4001, the UE 401 signals the network access node 402. This signalling may comprise a message known as “message 1” (Msg1) of a random access procedure. In some examples, Msg1 is a Physical RACH (PRACH) preamble. RACH Msg1 may be referred to as PRACH. As mentioned above, the UE 504 may transmit a PRACH preamble on resources specified by a RACH configuration included in SIB2. Throughout the following, the terms “RACH” and “random access” (RA) will be used interchangeably.

During 4002, the network access node 402 signals the UE 401. This signalling may comprise a response to the PRACH preamble. The signalling of 4002 may comprise a message known as a message 2 (Msg2) of the random access procedure. The RACH Msg2 may be referred to as a random access response (RAR). The time difference between the network access node 402 receiving Msg1 and transmitting Msg2 is known as a RAR window.

In some examples, the UE monitors for the RACH Msg2 on resources specified by the random access configuration during the RAR window specified by the random access configuration. In some examples, the UE 401 may decode a downlink control information (DCI) signalling carried on a Physical downlink control Channel (PDCCH) that includes scheduling information of RAR information, in RAR information such as, for example, an UL grant for the UE to transmit a message 3 (Msg3) of the random access procedure during 4003. The UE 401 receives RAR information for transmitting Msg3, which provides an uplink grant.

During 4003, the UE 401 signals the network access node 402. This signalling may comprise a message known as a message 3 (Msg3) of the random access procedure. In some examples, the RACH Msg3 is a connection request.

During 4004, the network access node 402 signals the UE 401. This signalling may be a response to Msg3. This signalling may comprise a message known as a message 4 (Msg4) of the random access procedure. In some examples, the Msg4 is a contention resolution message. The time between receipt of Msg3 at the network access node and transmission of Msg4 by the network access node is known as a contention resolution window.

Although not shown, subsequent to Msg4 being received by the UE 401, the UE 401 and the network access node 402 may establish an RRC connection and enter an active operational phase where data may be exchanged. Stated differently, after Msg4 is received by the UE, the network access node may schedule the UE for UL communication and/or DL communication on the cell through which the UE connects to the network access node.

Further, for the Random Access procedure of FIG. 4A, as part of during transmission of msg1 there are certain access parameters that the UE uses to determine the target power. These include, for example, a time to wait for a response from the network (ra-ResponseWindow), a maximum number of retransmissions of Msg1 (preambleTransMax), a power ramping factor between retransmissions of Msg1 (powerRampingStep), and a target receive power of Msg1 (preambleReceivedTargetPower).

FIG. 4B illustrates another type of random access procedure that may be performed between a UE 401′ and a network access node 402′.

During 4001, the UE 401′ signals the network access node 402′. This signalling may comprise a first message known as a “Message A” (MsgA). This signalling may be sent on a physical uplink shared channel (PUSCH). This signalling on 4001′ may comprise a payload transmission.

During 4002′, the network access node 402′ signals the UE 401′. This signalling may comprise a message known as a “Message B” (MsgB). MsgB may be considered as a contention resolution message in that it distinguishes between UE accessing the cell. MsgB may be signalled in response to the signalling of 4001′. MsgB may be considered as a combination of Msg2 and Msg4 in that it responds to a MsgA, and performs a contention resolution function.

The time taken between receive of MsgA during 4001′ and transmission, by the network access node, of MsgB during 4002′, is the sum of an RAR window and a contention resolution window, and is normally less that the time between 4001 and 4004 in FIG. 4A.

Assuming the contention resolution of 4002′ is successful, the UE 401′ and the network access node 402′ may establish an RRC connection and enter an active operational phase where data may be exchanged. Stated differently, after MsgB is successfully received by the UE, the network access node may schedule the UE for UL communication and/or DL communication on the cell through which the UE connects to the network access node.

In the event that the procedure of FIG. 4B is unsuccessful, the UE may instead be caused to perform the procedure of FIG. 4A. For example, the UE may, in response to (e.g., based on) determining that a preconfigured number of MsgA transmissions have been performed without successfully receiving a MsgB, switch to transmitting a Msg1. As another example, the network access node may instruct the UE to switch to transmitting a Msg1 when the network access node determines that there is a problem in transmitting a MsgB and/or in receiving MsgA.

For both of these examples, the random access procedure uses an open loop power control mechanism, where the UE determines the power to transmit the preamble based on

$${P}_{PRACH , b , f , c} ( i ) = min \{ {P}_{MCAX , f , c} ( i ) , {P}_{PRACH , target , f , c} + {PL}_{b , f , c} \} [ dBm ] ,$$

PCMAX=UE configured maximum output power
P_{RACH,target}=PRACH target reception power (PREAMBLE_RECEIVED_TARGET_POWER) signalled via SIB1
PL=Pathloss which is calculated as reference signal power—layer 3 reference signal received power (L3 RSRP), where the reference signal power is provided as a value via the SIB (e.g., the value of the field ss-PBCH-BlockPower signalled via SIB1).

As seen above, one of the components that the UE uses to determine the uplink transmit power for PRACH is the pathloss which is based on the RSRP of the SSB mapped to the random access occasions on which the UE will transmit the preamble.

Reference is also made in the below to quasi-co-location (QCL).

In more detail, there exists situations in which at least one of the channel degradation conditions experienced when transmitting by a first antenna of the UE is similar to at least one of the channel degradation conditions experienced when transmitting by a second antenna of the UE. In such a situation, the network access node and/or UE may exploit this similarity when determining parameters for uplink transmission by grouping together “similar” antennas and causing at least some common set of uplink transmission parameters to be used within that group of antennas. This grouping together of antennas for such a purpose is also referred to as quasi-colocation (QCL).

3GPP has defined QCL as per the following: “Two antenna ports are said to be quasi co-located if properties of the channel over which a symbol on one antenna port is conveyed can be inferred from the channel over which a symbol on the other antenna port is conveyed”.

QCL-based methods may help a UE with channel estimation, frequency offset error estimation and synchronization procedures, and setting receive and transmit beam properly. In more detail, when a UE knows that the channel degradation conditions corresponding to two different antenna ports is QCL in terms of Doppler shift, then UE can determine Doppler shift for one antenna port and then apply the result on both antenna ports for channel estimation. This avoids the UE to calculate doppler for both antenna port separately. Similar principles may be applied in respect of any of the above-mentioned channel degradation conditions.

Various combinations of these channel degradation conditions have been grouped together to form various quasi-co-location QCL types. For example, QCL-TypeA refers to QCL that comprises doppler shift, doppler spread, average delay and delay spread, QCL-TypeB refers to QCL that comprises doppler shift and doppler spread, QCL-TypeC refers to QCL that comprises average delay and doppler shift, and QCL-TypeD refers to QCL that comprises a spatial parameter.

Which QCL-Type is applied between two antenna is determined by a combination of a transmission control indicator reference signal (TCI-RS)-Set and a demodulation reference signal (DMRS) (see, for example, 3GPP TS 38.214-5.1.5 Antenna ports quasi co-location “, which details a mapping between QCL-Type and TCI-RS-Set”

It is noted that QCL techniques are not limited to grouping together only uplink antenna together or only downlink antenna together. For example, a combination of uplink and downlink antenna may be grouped together where their channel degradation properties are similar. In such scenarios, there may exist QCL relations between a source signal and a target signal. In general, the term “source signal” is used herein to indicate a signal whose channel degradation properties are to be measured for calculating parameters for addressing at least one channel degradation effect, and the term “target signal” is used herein to indicate a signal that is received and/or transmitted using at least one of said parameters. Stated differently, the target signal is a signal to be received and/or transmitted that is QCL with the source signal, The source signal described herein is often a reference signal, such as a periodic channel state indictor reference signal (CSI-RS).

FIG. 2 illustrates an example of a control apparatus 200 for causing a network device 120 (such as the network device described in FIG. 1) to perform its operations. The control apparatus may comprise at least one random access memory (RAM) 211a, at least on read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the network device. In some embodiments, each function of the network device comprises a control apparatus 200. In some exemplary embodiments, the apparatus 200 may be implemented at the network device 120 or may be the network device 120.

FIG. 3 illustrates an example of a terminal 300, such as the user device 110, 115 illustrated on FIG. 1. The terminal 300 may be provided by any device capable of sending and receiving radio signals, such as the user device described herein. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3 transceiver apparatus is designated schematically by block 306. The transceiver apparatus 306 may be provided for example by means of a radio part and associated antenna arrangement. The antenna arrangement may be arranged internally or externally to the mobile device.

The terminal 300 may be provided with at least one processor 301, at least one memory ROM 302a, at least one RAM 302b and other possible components 303 for use in software and hardware aided execution of tasks it is designed to perform, including control of access to and communications with access systems (such as a network access system provided by the network device described above in relation to FIGS. 1 and 2) and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus can be provided on an appropriate circuit board and/or in chipsets. This feature is denoted by reference 304. The device may optionally have a user interface such as key pad 305, touch sensitive screen or pad, combinations thereof or the like. Optionally one or more of a display, a speaker and a microphone may be provided depending on the type of the device.

In some exemplary embodiments, the terminal 300 may be an apparatus comprising at least one processor and at least one memory storing instructions that, when executed by the at least one processor, cause a user device 110, 115 to perform examples or embodiments described in this document.

In 3GPP Release 19, it has been proposed that network access nodes, such as described above in relation to FIGS. 1 and 2, may implement a multi-carrier single cell. An example multi-carrier single cell is illustrated with respect to FIG. 5.

FIG. 5 illustrates a multi-carrier cell as a single logical cell 501 that is provided by an access network node. The single logical cell comprises a plurality of frequency bands 502-505 that may not be contiguous with respect to each other. Stated differently, the single logical cell illustrated in FIG. 5 is comprised of fragmented spectrum that are grouped to form a single logical cell.

Although not shown in FIG. 5, the multi-carrier cell is configured as a single logical cell 501 by causing one of the frequency bands 502-505 to comprise system information for the other frequency bands of the multi-carrier cell. This may enable the collection of frequency bands 502-505 to functionally act as a single wideband cell instead of a collection of disparate narrowband frequency ranges.

For example, in the example of FIG. 5, system information (e.g., SIB1) is transmitted only in 504, and contains information about all the other bands in the cell 502, 503, 505 as well as itself 504. A UE that is configured to receive the signalling of 501 may therefore first read the SIB1 in 504, and then perform random access based on the information transmitted in the SIB1.

Implementing a multi-carrier cell as a single logical cell 501 may be especially advantageous in situations in which operators have fragmented spectrum that are narrowband, which may be especially prevalent in certain regions. For example, each narrowband carrier provided by such network access nodes may be associated with a relatively high system overhead when implemented alone. Therefore, by implementing a collection of such carriers as a single logical cell with system information being provided for other carriers on a single carrier, the network resources may be made for efficient.

However, of the multiple frequency bands (e.g., frequency ranges and/or carriers) that may be a part of the logical cell, specific UEs may be configured to support most of the bands in the downlink, but may be configured to only support a subset of these frequency bands in the uplink. Stated differently, a UE may be configured to receive on more frequencies than the UE is able to transmit on.

The UE may therefore receive system information in the downlink on a first frequency band, but may be unable to transmit a random access message on that first frequency band. Similarly, the UE may be configured to receive system information in the downlink on a first frequency band, and to perform a random access procedure on another frequency band. In both of these cases, the currently defined random access procedure described above as the random access occasion(s) on which to transmit a PRACH preamble is not identified.

In more detail, as mentioned above, there is an association between the SSB index and the random access occasion which helps the UE to determine the random access occasion on which it has to transmit the preamble (e.g., Msg1 or MsgA) once the UE has determined the SSB beam and the corresponding uplink based on beam correspondence that it would prefer to use. These random access occasions were defined in 3GPP under an assumption that a cell has a single frequency band, and so random access occasions are provided over the same carrier as the SSB under current 3GPP schemes.

However, this may lead to problems for multi-carrier cells. For example, a multi-carrier single cell comprises multiple frequency bands while the SIB1 and SSB is only transmitted on one of those frequency bands. Consequently, when the UE is not capable of transmitting in the uplink on the same frequency band on which it has received the SIB1 and the SSB, then the UE is unable to determine where in frequency and when in time the UE can transmit the preamble.

The following aims to address at least one of the above-mentioned issues.

In particular, the following discloses at least one method in which an apparatus (e.g., a UE) can receive system information over a first carrier provided by a multi-carrier cell, wherein the system information comprises information indicating an association between SSBs transmitted over the first carrier and first random access occasions that are available for uplink random access transmissions over the first carrier. The apparatus may use this system information (e.g., may use at least part of the information indicating the association) to identify at least one second random access occasion that is available for uplink random access transmissions over a second carrier provided by the multi-carrier cell. The identified at least one second random access occasions may subsequently be used for an uplink random access transmission (e.g., a transmission of Msg1 and/or MsgA).

The identified at least one second random access occasion used for transmission may also be used to determine a resource on which a response will be provided to the apparatus (e.g., to determine a resource on which a Msg2 and/or MsgB will be received from the network).

For example, the at least one second random access occasion (e.g., at least one time-frequency resource) may be mappable to the resource(s) on which the response will be provided using either a preconfigured mapping algorithm (e.g., a preexisting relationship that can be expressed as a mapping algorithm), and/or may be found using some other techniques (such as, for example, when these two sets of resources are QCL with each other).

It is further understood that an apparatus that is employing the presently described principles may also determine a power at which to transmit the uplink random access message during the at least one second random access occasion.

In more detail, as will be described further below, information that can be used to determine what power to transmit random access messages during the first random access occasions is provided in system information. The following also describes a method for determining a power for transmitting uplink random access message during the second random access occasions based on the information for determining what power to transmit random access messages during the first random access occasions. This may be, for example, based on measured reference signal receive power (RSRP) and/or pathloss-based information.

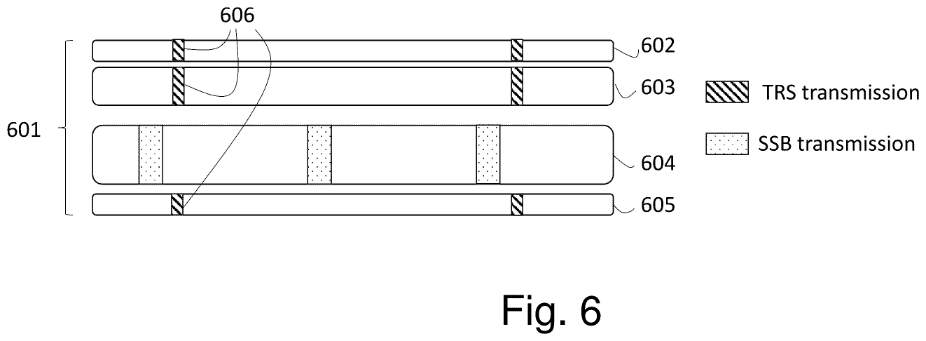

At least some of the above-mentioned principles are illustrated with respect to the examples of FIGS. 6 to 11.

FIG. 6 illustrates example resources provided in a multi-carrier cell 601 (e.g., a cell comprising a plurality of frequency bands where system information is provided on one of the plurality of frequency bands for the other of the plurality of frequency bands).

The multi-carrier cell 601 comprises a first frequency band 602 associated with a first carrier, a second frequency band 603 associated with a second carrier, a third frequency band 604 associated with a third carrier, and a fourth frequency band 605 associated with a fourth carrier. In the example of FIG. 6, system information for the first to fourth frequency bands 602-605 is provided on the third frequency band (e.g., over the third carrier). This is illustrated in FIG. 6 by the provision of SSBs on the third frequency band 604 that are transmitted every 20 ms.

The first, second, and fourth frequency bands 602, 603, 605 are also illustrated as providing reference signals 606. In the following, these reference signals will be labelled as tracking reference signals. However, it is understood that any type of reference signal may be used for the presently described techniques.

In relation to tracking reference signals, 3GPP Rel-17 defined a Tracking Reference Signal (TRS) for UEs operating in reduced energy mode (e.g., in a radio resource control (RRC) idle mode and/or in an RRC inactive mode). UE power saving in the reduced energy mode may be achieved by providing a connected mode configuration for receiving a TRS during at least one TRS occasion. The TRS may be part of the channel state information reference signal (CSI-RS). The TRS in TRS occasions may allow UEs in the reduced energy mode to sleep longer before waking-up for its paging occasion. The TRS occasions configuration is currently provided in SIB17. The availability of TRS in the TRS occasions is indicated by a layer 1 (L1) availability indication provided in the SIB17.

According to 3GPP TS 38.331, the highest configurable allocation of TRS is two consecutive slots, with 2 symbols per slot TRS for an RRC idle mode and a periodicity of 10 slots. The TRS occasions can be configured to reduced energy mode UEs via the RSResourceSetConfig field provided in SIB17 (e.g., using a TRSResourceSetConfig field). The TRSResourceSetConfig field may comprise up to 64 TRSResourceSets. Each TRSResourceSet configures a set of NZP-CSI-RS resources (2 or 4 resources). Quasi-collocated (QCL) association of resource set is given towards an SSB (ssb-Index) (e.g., QCL typeC and QCL typeD, when applicable). Each TRS resource set is given an index of the associated bit in TRS availability indication (indBitID). The validity of such TRS allocation may be configured by network.

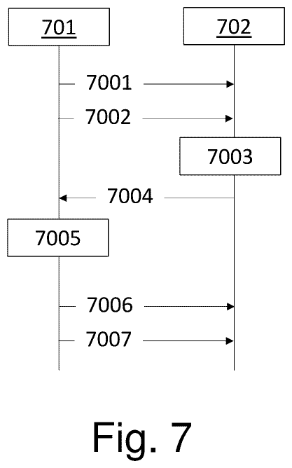

FIG. 7 illustrates example signalling between a network access node 701 and a UE 702. The network access node 701 is configured to provide the multi-carrier cell 601 of FIG. 6. The UE is configured to receive on any of the first to fourth frequency bands 602-605. The UE is configured to transmit on any of the first, and second frequency bands 602, 603, but not to transmit on the third frequency band.

During 7001, the network access node 701 signals the UE 702. This signalling may be broadcast. This signalling may comprise system information. This signalling may comprise an SIB1. This signalling may be provided over the third frequency band 604. This signalling may comprise information about a mapping between a TRS on the second frequency band 603 and an SSB transmitted on the third frequency band 604. This signalling may comprise information for a mapping between one or more random access occasions on the second frequency band, and the TRS on the second frequency band 603.

During 7002, the network access node 701 transmits a TRS on the second frequency band in accordance with the TRS information provided in the signalling of 7001. 7002 may be performed contemporaneously with the signalling of 7001 (e.g., during a same timing instance, but at different frequencies). Stated differently, the signalling of 7001 and 7002 may be frequency division multiplexed together. However, it is understood that 7001 and 7002 may be performed at different times. Stated differently, the signalling of 7001 and 7002 may be time division multiplexed together.

During 7003, the UE 702 reads SIB1 comprised in the system information of 7001, and scans for the TRS of the second frequency band. The UE may determine a band (e.g., the second frequency band) and at least one random access occasions on the second frequency band for transmitting a random access preamble. The UE may further determine a power for transmitting the preamble on the second frequency band, such as described herein.

During 7004, the UE 702 transmits a random access preamble to the network access node 701 over the second frequency band. This may be as described in relation to 4001 and/or 4001′. The random access preamble may be transmitted using the at least one random access occasion determined during 7003.

During 7005, the network access node 701 determines, based on the signalling of 7004, at least one resource to use for transmission of information based on the signalling of 7004.

For example, during 7005, the network access node 701 identifies a least one resource (e.g., at least one time-frequency resource) on the physical downlink control channel (PDCCH) that is quasi-collocated (QCL) with the random access occasion used for transmission during 7004, and at least one resource on the physical downlink shared channel (PDSCH) that is QCL with the random access occasion used for transmission during 7004. It is understood in the following that a random access occasion may be considered to be one or more time-frequency resource.

During 7006, the network access node uses the PDCCH resource(s) determined during 7005 to transmit downlink control information.

During 7007, the network access node uses the PDSCH resource(s) determined during 7005 to transmit random access information (e.g., information transmitted during 4002 or 4002′).

In this example of FIG. 7, a network access node is configured to transmit reference signals (e.g., Tracking Reference Signal (TRS)) on frequency bands that are not transmitting the SSB and SIB. Information about the reference signal (e.g., where to find it) is provided in SIB1. These reference signals may be considered as a source QCL-RS to channels used for transmission of a random access response and/or for transmission of downlink control information. The random access occasion are mapped to the TRS. During the random access procedure, the demodulation reference signal (DMRS) port of the PDSCH channel transmitting the random access response and the DMRS port of the PDCCH channel transmitting the DCI each have a QCL relation with the TRS associated with the random access occasions on which the UE has transmitted the preamble.

The UE of FIG. 7 may select a random access occasion in any of a plurality of different ways.

For example, the random access occasion(s) to be used for transmitting the preamble may be mapped relative to another reference signal transmitted by the network access node for reduced energy mode UEs (such as, for example, TRS). The SIB1 may comprise information mapping the random access occasions to this reference signal. As mentioned above, the reference signal on such a frequency band not transmitting the SSB may be treated as the source QCL-reference signal to later transmitted downlink signals (e.g., as described in the example of FIG. 7).

In another example, the random access occasions (on a frequency band not transmitting the SSB) may be mapped to the SSB being transmitted on different frequency band.

As another example, the random access occasions mapping on other bands may be implicitly based on the SSB to random access occasions mapping on the band where SSB is being transmitted. For example, assuming a multi-carrier single cell setup that provides two frequency bands (b1 and b2), where SSB is transmitted on b1 (e.g., like the SSBs transmitted on frequency band 604) while TRS is transmitted on b2 (e.g., any of frequency bands 602, 603, 605). In this case, the TRS on b2 may have a QCL relation with the SSB on b1. Further, the random access occasions to TRS mapping on b2 may replicate the mapping between the random access occasions to SSB provided in the SIB.

It is further understood that the reference signal (e.g., the TRS) may be selected in any of a plurality of different ways. These are illustrated below with reference to FIG. 6.

As a first example, the UE may select a frequency band for transmission of the random access preamble that is not the lowest frequency band. In more detail, since the logical cell is a composition of multiple frequency bands, ideally when a UE scans the various frequencies, the UE would prefer to select the lowest frequency band for connection in order to maximize coverage. However, this may result in a disproportionate number of UEs trying to access the cell via the lower frequency bands, which in turn will result in higher collision probability. It may therefore be advantageous for the UE to instead select and perform random access procedures on a different frequency band (e.g., any of 603 or 605) to make is more likely that the random access procedures. The UE may select any of frequency bands 603 or 605, provided the RSRP of the reference signal on these frequency bands is not extremely low (e.g., a measured RSRP of a reference signal on frequency band 603 (or 605) is above a preconfigured threshold amount). The UE in such cases may therefore opt to maximize its chance of a successful random access instead of maximizing its coverage.

As another example, the UE may select a frequency band for random access based on the power headroom available. For example, when the UE has enough power available, the UE may select frequency band 605 to carry out random access as the UE has enough power to transmit the preamble as well as to perform a power ramp up if necessary. If the power headroom is low or is close to zero, then the UE may select a frequency band having a lower frequency than 605 to carry out random access procedures. The power headroom is the difference between the nominal UE maximum transmit power and the estimated power (in the equations above).

In any of the preceding two examples, the UE may default to a lower frequency band when an initial random access procedure performed via a higher frequency band has failed. Stated differently, a UE may first select and perform random access on the higher frequency band first and, when the UE does not receive a random access response and/or when the random access procedure otherwise fails, the UE may attempt a random access procedure on a lower frequency band.

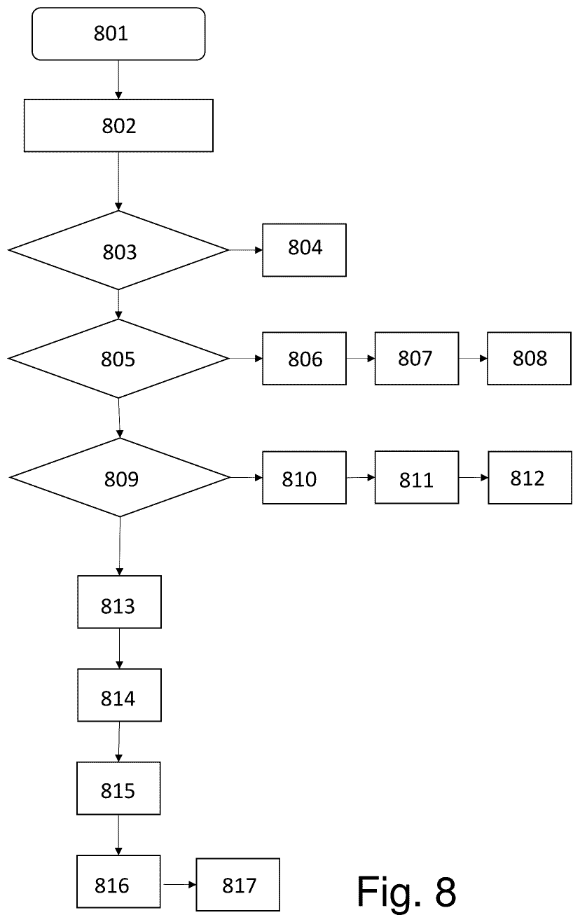

FIG. 8 illustrates a flow chart of an example method that may be performed by a UE when selecting a random access occasion.

During 801, the method starts.

During 802, the UE reads SIB1 from a received SSB.

During 803, the UE determines whether the UE can perform random access on the same frequency band over which the SSB was transmitted.

When the UE determines during 803 that the UE can perform random access on the same frequency band over which the SSB was transmitted, the UE proceeds to 804.

During 804, the UE determines random access occasions on the frequency band over which the SSB was transmitted using an association between the random access occasions on the frequency band over which the SSB was transmitted and the SSB that was comprised in the received SSB.

When the UE determines during 803 that the UE cannot perform random access on the same frequency band over which the SSB was transmitted, the UE proceeds to 805.

During 805, the UE determines whether there is a mapping available to the UE that maps the SSB to random access occasions in a different frequency band to the frequency band over which the SSB was transmitted. For example, the UE may determine whether there is a mapping available in the SSB (e.g., in SIB1) and/or in some other received signalling that maps the SSB to random access occasions in a different frequency band to the frequency band over which the SSB was transmitted. As another example, the UE may determine whether the UE is otherwise configured with information that maps the SSB to random access occasions in a different frequency band to the frequency band over which the SSB was transmitted.

When the UE determines during 805 that there is a mapping available to the UE that maps the SSB to random access occasions in a different frequency band to the frequency band over which the SSB was transmitted, the UE proceeds to 806.

During 806, the UE selects an SSB. This selection may select an SSB having a “best” signal quality metric associated therewith. For example, this selection may select an SSB having a “best” reference signal received power (RSRP) out of SSBs received by the UE.

During 807, the UE determines a power for transmitting a random access preamble based on the selected SSB of 806. For example, the value of the best RSRP associated with the selected SSB of 806 may be used for determining a pathloss for determining the power, as described above.

During 808, the UE transmits a random access preamble on at least one of the random access occasions on the different frequency band using the transmission power determined during 807.

When the UE determines during 805 that there is not a mapping available to the UE that maps the SSB to random access occasions in a different frequency band to the frequency band over which the SSB was transmitted, the UE proceeds to 809.

During 809, the UE determines whether there is a mapping available that maps a reference signal (e.g., a TRS) to a random access occasions on the different frequency band. The mapping may be, for example, an explicit mapping.

When the UE determines during 809 that there is a mapping available that maps a reference signal (e.g., a TRS) to a random access occasions on the different frequency band, the UE proceeds to 810.

During 810, the UE selects a reference signal. This selection may select a reference signal having a “best” signal quality metric associated therewith. For example, this selection may select a reference signal having a “best” RSRP out of reference signals received by the UE. The reference signal selected during 810 is transmitted using a different frequency band to the frequency band used for transmission of the SSB.

During 811, the UE determines a power for transmitting a random access preamble based on the selected reference signal of 810. For example, the value of the best RSRP associated with the selected reference signal of 810 may be used for determining a pathloss for determining the power, as described above.

During 812, the UE transmits a random access preamble on at least one of the random access occasions on the different frequency band using the transmission power determined during 812.

When the UE determines during 809 that there is no mapping available that maps a reference signal (e.g., a TRS) to a random access occasions on the different frequency band, the UE proceeds to 813.

During 813, the UE selects a reference signal. This selection may select a reference signal having a “best” signal quality metric associated therewith. For example, this selection may select a reference signal having a “best” RSRP out of reference signals received by the UE. The reference signal selected during 813 is transmitted using a different frequency band to the frequency band used for transmission of the SSB.

During 814, the UE determines an SSB that is QCL with the selected reference signal of 813.

During 815, the UE obtains a mapping of the determined SSB to random access occasions in the same frequency band that was used for transmission of the determined SSB. The UE determines to apply this obtained mapping to the TRS to identify random access occasions that are available over the same frequency band as was used for transmission of the TRS.

During 816, the UE determines a power for transmitting a random access preamble based on the selected reference signal of 813. For example, the value of the best RSRP associated with the selected reference signal of 813 may be used for determining a pathloss for determining the power, as described above.

During 817, the UE transmits a random access preamble on at least one of the random access occasions on the frequency band of the TRS using the transmission power determined during 816.

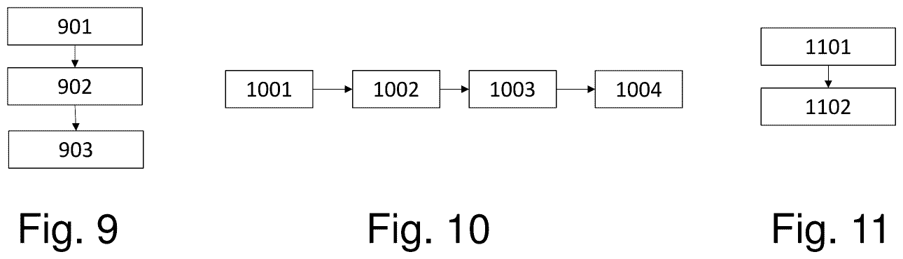

At least some of the above-mentioned features are illustrated with respect to the apparatus described in FIGS. 9 to 11. It is therefore understood that at least some of the above description may be used to illustrate how one or more of the following described methods may be implemented.

FIG. 9 illustrates a method that may be implemented by an apparatus. The apparatus may comprise a UE (such as described above in relation to FIG. 3). The apparatus may be comprised in a UE.

During 901, the apparatus receives system information over a first carrier provided by a multi-carrier cell that is configured to support the first carrier and a second carrier. The first and second carriers are carriers of different frequency bands supported by the multi-carrier cell. The system information indicates an association between synchronisation signal blocks transmitted over the first carrier and first random access occasions that are available for uplink random access transmissions over the first carrier. As discussed above, random access occasions may be considered to be time-frequency resource(s) that are available for uplink random access transmissions.

The multi-carrier cell may be considered to be a single logical cell. The multi-carrier cell may be configured to provide system information on one of its carriers that applies in respect of the other carriers supported by the other carriers of the multi-carrier cell.

During 902, the apparatus identifies, based on the system information, at least one second random access occasion for performing an uplink random access transmission over the second carrier provided by the multi-carrier cell.

During 903, the apparatus transmits an uplink random access message over the second carrier during the identified at least one second random access occasion.

FIG. 10 illustrates a method that may be implemented by an apparatus. The apparatus may comprise a UE (such as described above in relation to FIG. 3). The apparatus may be comprised in a UE.

During 1001, the apparatus receives system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier. This may be as described above in relation to 901.

During 1002, the apparatus selects the second carrier.

During 1003, the apparatus identifies, based on the system information, at least one second random access occasion for performing an uplink random access transmission over the second carrier provided by the multi-carrier cell.

During 1004, the apparatus transmits an uplink random access message over the second carrier during the identified at least one second random access occasion

The selecting the second carrier may be performed in any of a plurality of different ways when there are more than two carriers provided by the multi-carrier cell.

For example, the apparatus may select the second carrier by: determining a plurality of carriers supported by the multi-carrier cell, wherein the plurality of carriers comprises at least the first carrier, the second carrier, and a third carrier, determining that the third carrier corresponds to a lower frequency range than the second carrier; and selecting the second carrier based on the determination that the third carrier corresponds to a lower frequency range than the second carrier. Stated differently, the apparatus may be configured to select a carrier that does not correspond to a frequency range having the lowest frequency as the second carrier.

In an example, the apparatus may be configured to select the carrier corresponding to a highest frequency range available out of the plurality of carriers as the second carrier.

The apparatus may determine that a random access procedure initiated by the uplink random access message transmission over the second carrier has failed, determine that the third carrier has a second highest frequency range available out of the plurality of carriers, and select the third carrier for transmission of another uplink random access message based on the determination that the third carrier has a second highest frequency range available out of the plurality of carriers and the failure of the random access procedure initiated by the uplink random access message transmitted over the second carrier.

As another example, the selecting the second carrier may comprise determining a plurality of carriers supported by the multi-carrier cell, wherein the plurality of carriers comprises at least the first carrier, the second carrier, and a third carrier, determining that the second carrier has a larger amount of power headroom available than the third carrier for transmitting the uplink random access message, and selecting the second carrier based on the preceding determination.

In relation to this, it is noted that the power headroom relates to additional power available at the UE for an uplink transmission relative to its latest uplink transmission power. In general, the higher the transmission frequency, the less coverage is available to the UE (e.g., transmissions made using a frequency band at 800 MHz will provide greater coverage compared to transmissions made using a frequency band at 3.5 GHz). As a result of this, the UE may use more power to transmit uplink on a 3.5 GHz carrier to achieve a comparable reliability to uplink transmissions made on a 800 MHz carrier. It may therefore be useful for the UE to consider power headroom when selecting which carrier to use for an uplink transmission for a random access procedure, either as a sole criterion for selecting the second carrier, or in combination with one or more other selection criteria.

As another example, some combination of the other methods may be applied by the apparatus. For example, the selecting the second carrier may comprise: determining a plurality of carriers supported by the multi-carrier cell, wherein the plurality of carriers comprises at least the first carrier, the second carrier, and a third carrier, determining that the second carrier corresponds to a higher frequency range than that of the third carrier, determining that a power headroom of the apparatus would be equal to or more than a threshold amount of zero if the uplink random access message is transmitted over the second carrier, and selecting the second carrier based on the preceding two determinations.

As another example, the apparatus may select the second carrier by: determining a plurality of carriers supported by the multi-carrier cell, wherein the plurality of carriers comprises at least the first carrier, the second carrier, and a third carrier, determining that the second carrier corresponds to a lower frequency range than the third carrier, determining that a power headroom of the apparatus would be equal to or more than a threshold amount of zero if the uplink random access message is transmitted over the second carrier, determining that the power headroom of the apparatus would be within the threshold amount of zero if the uplink random access message is transmitted over the third carrier, and selecting the second carrier based on the preceding three determinations. The threshold amount may be zero. The threshold amount may be more than zero.

For all of the above-mentioned examples of selecting the second carrier, the apparatus may be configured to select another carrier for transmitting an uplink random access message (e.g., for transmitting Msg1 and/or MsgA) if the random access procedure conducted over the second carrier fails.

The following may apply in respect of the apparatus of any (e.g., one or more, including all) of the FIGS. 9 and 10.

The identifying of 902 and/or 1003 may be performed in any of a plurality of different ways.

The identifying of 902 and/or 1003 may use at least part of the information indicated by the above-mentioned association of SSB(s) to first random access occasions. Stated differently, information mapping an SSB of the first carrier to a first random access occasion provided by the first carrier may be used to identify at least one second random access occasion provided by the second carrier.

For example, at least part of the association information may be used for identifying the resources on the second carrier (e.g., either by identifying the second random access occasions based on the SSB in the association information, or by identifying a reference signal (e.g., a TRS), and performing a subsequent mapping to identify the at least one second random access occasions.

Further examples of using at least part of the association information comprised in the system information for identifying a second random access occasion are described herein.

The identifying the at least one second random access occasion may comprise: identifying the second carrier, receiving an association between the second carrier and the at least one second random access occasion, and identifying the at least one second random access occasion based on the identified second carrier, and the association between the second carrier and the at least one second random access occasion. The second carrier may be identified by, for example, determining a TRS that is QCL with an SSB, or by a TRS that is indicated by the network node (e.g., via the system information or via some other signalling), or by determining a default TRS that is preconfigured to be used.

The identifying the at least one second random access occasion may comprise: mapping the at least one of the synchronisation signal blocks transmitted over the first carrier to the at least one second random access occasion using a mapping algorithm.

The identifying the at least one second random access occasion may comprise: determining a mapping algorithm between the synchronisation signals blocks and the first random access occasions based on the system information; identifying a reference signal of the second carrier that is quasi co-located to at least one of said synchronisation signal blocks; and identifying the at least one second random access occasion based on the determined mapping algorithm and the identified at least one quasi-collocated resource.

The second carrier may be associated with a reference signal. For example, the second carrier may be associated with the tracking reference signal. The reference signal (e.g., the tracking reference signal) may be quasi-collocated with at least one of said synchronisation signal blocks. In such a case, the quasi-colocation is based on at least one of a spatial receive parameter, a Doppler shift, or an average receive delay time. For example, the QCL type may be at least one of TypeC or TypeD.

The apparatus may receive a downlink random access message after transmitting the uplink random access message, wherein the downlink random access message is received on resources that are quasi-collocated with resources used for transmission of the random access preamble on the uplink. The downlink random access message may be, for example, msg2 and/or msgB. The uplink random access message may be, for example, msg1 and/or msgA.

As discussed above, the apparatus of FIGS. 9 and/or 10 may further select a transmission power for transmitting the uplink random access message on the at least one second random access occasion.

For example, the apparatus may determine, based on the system information, a transmission power for transmitting a random access message on the first carrier, and receive a reference signal power for the second carrier based on the determined transmission power for transmitting a random access message on the first carrier. The random access message mentioned in this paragraph may correspond to a message for transmitting a random access preamble. Stated differently, the random access message on the first carrier may comprise a random access preamble For example, this information may be for transmitting a Msg1 and/or a MsgA. The transmitting the uplink random access message over the second carrier during the identified at least one second random access occasion may further comprise transmitting the uplink random access message during the identified at least one second random access occasions using said determined power.

As another example, the apparatus may obtaining receive a reference signal power for the second carrier from via the system information, determining a pathloss based on the obtained received reference signal power, and determine a power for transmission based on the pathloss. In such a case, the transmitting the uplink random access message over the second carrier during the identified at least one second random access occasion may further comprise transmitting the uplink random access message during the identified at least one second random access occasions using said determined power.

As another example, the determining the power may comprise: determining a pathloss based on a value comprised in the system information, and determining a power based on the pathloss. In such a case, the transmitting the uplink random access message over the second carrier during the identified at least one second random access occasion may comprise transmitting the uplink random access message during the identified at least one second random access occasions using said determined power.

The apparatus may determining that the apparatus is not configured to transmit uplink over the first carrier. In such a case, the identifying is performed based on (e.g., in response to) said determining that the apparatus is not configured to transmit uplink over the first carrier. However, as mentioned above, it is not necessary for the apparatus to be limited in such a way in order to apply the presently described principles.

FIG. 11 illustrates a method that may be performed by an apparatus that interacts with at least one of the apparatus of FIG. 9 or 10. The apparatus of FIG. 11 may comprise a network access node (e.g., a gNB), such as described above in relation to FIG. 2. The apparatus of FIG. 11 may be comprised in a network access node.

During 1101, the apparatus transmits, to a user equipment, system information, over a first carrier provided by a multi-carrier cell, that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier. This may be as described above in relation to FIGS. 9 and 10.

During 1102, the apparatus receives an uplink random access message over the second carrier during at least one second random access occasion, wherein the at least one second random access occasion is based on the system information. This may be as described above in relation to 903 and/or 1004.

As discussed above, the apparatus of FIG. 11 may provide a downlink random access message (e.g., a response to the signalling of 903 and/or 1004) using resources that are identified based on the resource used for transmission of the signalling of 903 and/or 1004.

For example, the apparatus may transmit, to the user equipment, a downlink random access message after transmitting the uplink random access message, wherein the downlink random access message is received on resources that are quasi-collocated with resources used for transmission of the uplink random access message.

The apparatus of FIG. 11 may further be caused to provide information to the apparatus of any of FIG. 9 or 10 with information for determining at what power to transmit the uplink random access message on the second carrier.

The system information may further comprise information for determining a power for transmitting the uplink random access message.

The information for determining a power for transmitting the uplink random access message may comprise at least one of: path loss information associated with the first carrier, path loss information associated with the second carrier, or a reference transmission power associated with the first carrier.

It is noted that whilst some embodiments have been described in relation to 5G networks, similar principles can be applied in relation to other networks and communication systems. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
(c) a combination of analog and/or digital hardware circuit(s) with software/firmware and
(d) any portions of hardware processor(s) with software (including digital signal processor(s)), software, and memory(ies) that work together to cause an apparatus, such as a mobile phone or server, to perform various functions) and
(e) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figs. may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1-16. (canceled)

17. An apparatus comprising:
at least one processor; and
at least one memory comprising code that, when executed by the at least one processor, causes the apparatus to perform:
receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier;
selecting the second carrier;
identifying, based on the system information, at least one second random access occasion for performing an uplink random access transmission over the second carrier provided by the multi-carrier cell; and
transmitting an uplink random access message over the second carrier during the identified at least one second random access occasion.

18. An apparatus as claimed in claim 17, wherein the selecting the second carrier comprises:
determining a plurality of carriers supported by the multi-carrier cell, wherein the plurality of carriers comprises at least the first carrier, the second carrier, and a third carrier;
determining that the third carrier corresponds to a lower frequency range than the second carrier; and
selecting the second carrier based on the determination that the third carrier corresponds to a lower frequency range than the second carrier.

19. An apparatus as claimed in claim 18, wherein the second carrier corresponds to a highest frequency range available out of the plurality of carriers.

20. An apparatus as claimed in claim 19, wherein the apparatus is further caused to perform:
determining that a random access procedure initiated by the uplink random access message transmission over the second carrier has failed;
determining that the third carrier has a second highest frequency range available out of the plurality of carriers, wherein the second highest frequency range being lower than the highest frequency range available out of the plurality of carriers; and
selecting the third carrier for transmission of another uplink random access message based on the determination that the third carrier has a second highest frequency range available out of the plurality of carriers and the failure of the random access procedure initiated by the uplink random access message transmitted over the second carrier.

21. An apparatus as claimed in claim 17, wherein the selecting the second carrier comprises:
determining a plurality of carriers supported by the multi-carrier cell, wherein the plurality of carriers comprises at least the first carrier, the second carrier, and a third carrier;
determining that the second carrier corresponds to a higher frequency range than that of the third carrier;
determining that a power headroom of the apparatus would be equal to or more than a threshold amount of zero if the uplink random access message is transmitted over the second carrier; and
selecting the second carrier based on the preceding two determinations.

22. An apparatus as claimed in claim 17, wherein the selecting the second carrier comprises:
determining a plurality of carriers supported by the multi-carrier cell, wherein the plurality of carriers comprises at least the first carrier, the second carrier, and a third carrier;
determining that the second carrier corresponds to a lower frequency range than the third carrier;
determining that a power headroom of the apparatus would be equal to or more than a threshold amount of zero if the uplink random access message is transmitted over the second carrier;
determining that the power headroom of the apparatus would be within the threshold amount of zero if the uplink random access message is transmitted over the third carrier; and
selecting the second carrier based on the preceding three determinations.

23. An apparatus as claimed in claim 17, wherein the identifying the at least one second random access occasion comprises:
identifying the second carrier;
receiving an association between the second carrier and the at least one second random access occasion; and
identifying the at least one second random access occasion based on the identified second carrier, and the association between the second carrier and the at least one second random access occasion.

24. An apparatus as claimed in claim 17, wherein the identifying the at least one second random access occasion comprises means for:
mapping the at least one of the synchronisation signal blocks transmitted over the first carrier to the at least one second random access occasion using a mapping algorithm.

25. An apparatus as claimed in claim 17, wherein the identifying the at least one second random access occasion comprises:
determining a mapping algorithm between the synchronisation signals blocks and the first random access occasions based on the system information;
identifying a reference signal of the second carrier that is quasi co-located to at least one of said synchronisation signal blocks; and
identifying the at least one second random access occasion based on the determined mapping algorithm and the identified at least one quasi-collocated resource.

26. An apparatus as claimed in claim 17, wherein the second carrier is associated with a tracking reference signal.

27. An apparatus as claimed in claim 26, wherein the tracking reference signal is quasi-collocated with at least one of said synchronisation signal blocks, and wherein the quasi-colocation is based on at least one of a spatial receive parameter, a Doppler shift, or an average receive delay time.

28. An apparatus as claimed in claim 17, wherein the apparatus is further caused to perform:
receiving a downlink random access message after transmitting the uplink random access message, wherein the downlink random access message is received on resources that are quasi-collocated with resources used for transmission of the random access preamble on the uplink.

29. An apparatus as claimed in claim 17, wherein the apparatus is a user equipment, UE, or wherein the apparatus is comprised in a UE.

30. An apparatus as claimed in claim 17, wherein the apparatus is further caused to perform: determining that the apparatus is not configured to transmit uplink over the first carrier, wherein the identifying is performed based on said determining that the apparatus is not configured to transmit uplink over the first carrier.

31. A method for an apparatus, the method comprising:
receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier;
selecting the second carrier;
identifying, based on the system information, at least one second random access occasion for performing an uplink random access transmission over the second carrier provided by the multi-carrier cell; and
transmitting an uplink random access message over the second carrier during the identified at least one second random access occasion.

32. A non-transitory computer readable medium comprising instructions, when executed by an apparatus, cause the apparatus to perform at least the following:
receiving system information over a first carrier provided by a multi-carrier cell that is configured to support the first carrier and a second carrier, wherein the first and second carriers are carriers of different frequency bands supported by the multi-carrier cell, and wherein the system information indicates an association between synchronisation signal blocks transmitted over the first carrier and first random access occasions that are available for uplink random access transmissions over the first carrier;
selecting the second carrier;
identifying, based on the system information, at least one second random access occasion for performing an uplink random access transmission over the second carrier provided by the multi-carrier cell; and
transmitting an uplink random access message over the second carrier during the identified at least one second random access occasion.
